(19) United States
(12) Patent Application Publication
(10) Pub. No.: US 2026/0000097 A1
(43) Pub. Date: Jan. 1, 2026

(54) FROZEN FOOD FOR MICROWAVE COOKING AND METHOD FOR PRODUCING SAME

(71) Applicant: NISSIN FOODS HOLDINGS CO., LTD., Osaka-shi, Osaka (JP)

(72) Inventors: Madoka TERASAWA, Osaka (JP); Takuma KAWAHARA, Osaka (JP)

(73) Assignee: NISSIN FOODS HOLDINGS CO., LTD., Osaka-shi, Osaka (JP)

(21) Appl. No.: 19/107,214

(22) PCT Filed: Jul. 21, 2023
(86) PCT No.: PCT/JP2023/026763

§ 371 Date: Feb. 27, 2025

(30) Foreign Application Priority Data
Aug. 31, 2022 (JP) 2022-137644

(51) Int. Cl. A23L 7/109; A23B 2/80; A23D 9/007; A23L 5/10; A23L 7/113; A23L 23/10

(52) U.S. Cl. CPC A23L 7/111; A23B 2/80; A23D 9/007; A23L 5/15; A23L 7/113; A23L 23/10

(57) ABSTRACT

The frozen food for microwave cooking is such that an upper side part or the entire surface of a cooked main ingredient is covered with a fat and/or oil-starch mixture containing 25 wt. % or less of starch in an amount of 3 to 20 wt. % based on the weight of the main ingredient, further on the upper side part of the main ingredient covered with the fat and/or oil-starch mixture, a concentrated liquid soup with a viscosity at 25° C. of 5 Pa·s or more is placed in an amount of 25 to 75 wt. % based on the weight of the main ingredient, and they are frozen in an integrated state. The frozen food for microwave cooking becomes ready to eat by pouring hot water after microwave cooking.

### TECHNICAL FIELD

The present invention relates to a frozen food for microwave cooking and a method for producing the same.

Conventionally, various frozen foods that can be easily ready to eat by microwave cooking are on the market. For frozen noodles and frozen rice meals, many products using microwave cooking have been developed. Particularly in recent years, frozen noodles have been developed not only for noodles that can be ready to eat only by heating in the microwave, such as pasta and yakisoba, but also for noodles with soup that can be ready to eat by adding a separately prepared soup to microwaved noodles and ingredients, such as ramen.

In the case of frozen noodles with soup for microwave cooking, the soup was generally packaged separately, resulting in packaging costs. In addition, since the soup was stored in packaged form until production, it was necessary to reduce packaging costs through concentration, adjust water activity to maintain shelf life, adjust pH, and so on. The flavor of the soup differed from that served in restaurants. Moreover, viscous soups, such as ankake ramen (starchy sauce ramen), thick tonkotsu ramen (creamy pork bone broth ramen), and tori-paitan ramen (creamy chicken broth ramen), were thickened with modified starch or thickeners, and the thickness of such soups felt artificial and unnatural.

As technology related to food products with viscous soup, such as ankake ramen, the techniques of Patent Literatures 1 and 2 are known.

Patent Literature 1 describes a base for thick soup, which prevents starch from forming lumps and adds sufficient thickness to the soup, the base for thick soup comprising at least a package A containing fat and/or oil and 10 to 70 mass % of starch with a gelatinization start temperature of 60° C. or less, and not containing a water-soluble liquid component, and a package B containing a seasoning composition. The soup prepared by dissolving and mixing the base for thick soup described in Patent Literature 1 by pouring hot water or water was actually less likely to form lumps, and the soup was viscous and thick enough; however, in particular, it was difficult to express natural thickness that occurs when livestock meat and bone, vegetables, and other raw materials are cooked in soups, such as rich pork bone ramen and chicken white soup ramen served in restaurants.

As a technique relating to a starch composition for frozen foods that prevents starch, which is blended to give high viscosity to soups, from forming lumps during cooking and eating, and that can be ready to eat by quick and easy cooking, and also relating to a frozen food using the starch composition, Patent Literature 2 describes a frozen food in which a portion of a starch composition having a mass ratio of starch to fat and/or oil of 3:7 or 7:3 is frozen as an integral part of either or both of main and sub ingredients, mixed in the gap between the main and sub ingredients. However, the technique of Patent Literature 2 has the following problems. Specifically, it is mainly for cooking by boiling, which can be stirred with chopsticks etc. while heating, and the starch composition has a large amount of starch to reduce fluidity because the starch composition is frozen together with the main ingredient. When cooked in the microwave, the starch composition is also heated by microwave cooking, and lumps are easily formed. This tendency is more pronounced in cases with high-moisture noodles and ingredients, and is considered to be caused by the starch being gelatinized by absorbing moisture when cooked in the microwave in contact with high-moisture ingredients.

### CITATION LIST

### Patent Literature

Patent Literature 1: Japanese Patent No. 6228755
Patent Literature 2: Japanese Patent No. 5409700

### SUMMARY OF INVENTION

### Technical Problem

An object of the present invention is to provide a frozen food for microwave cooking having a viscous soup when eaten, the soup having natural thickness like that of a soup eaten at a restaurant, and a method for producing the same.

### Solution to Problem

The inventor has intensively studied how to reproduce viscous soups, such as rich pork bone ramen and chicken white soup ramen, which are extracted from pork and chicken bones, vegetables, and the like by boiling over a long period of time in restaurants, in frozen noodles for microwave cooking, and has accidentally discovered the present invention. Thus, the present invention has been achieved.

That is, the present invention relates to a frozen food for microwave cooking, comprising a cooked main ingredient, a fat and/or oil-starch mixture, and a concentrated liquid soup, wherein an upper side part or the entire surface of the main ingredient is covered with the fat and/or oil-starch mixture, the concentrated liquid soup is placed on the upper side part of the main ingredient covered with the fat and/or oil-starch mixture, the main ingredient, the fat and/or oil-starch mixture, and the concentrated liquid soup is frozen in an integrated state, the fat and/or oil-starch mixture has a starch content of 25 wt. % or less, the weight of the fat and/or oil-starch mixture is 3 to 20 wt. % based on the weight of the main ingredient, the concentrated liquid soup has a viscosity at 25° C. of 5 Pa·s or more, the weight of the concentrated liquid soup is 25 to 75 wt. % based on the weight of the main ingredient, and the frozen food for microwave cooking becomes ready to eat by pouring hot water after microwave cooking.

In the frozen food for microwave cooking according to the present invention, a fat and/or oil in the fat and/or oil-starch mixture is preferably a non-Newtonian fluid at 25° C.

In the frozen food for microwave cooking according to the present invention, the main ingredient is preferably noodles.

The method for producing the frozen food for microwave cooking according to the present invention is, for example, a method for producing a frozen food for microwave cooking, comprising: filling a freezer container with a cooked main ingredient; placing a fat and/or oil-starch mixture from an upper side of the main ingredient, with which the freezer container is filled, in an amount of 3 to 20 wt. % based on the weight of the cooked main ingredient; placing a concentrated liquid soup from the upper side of the main ingredient, on which the fat and/or oil-starch mixture is placed, in an amount of 25 to 75 wt. % based on the weight of the cooked main ingredient; freezing the cooked main ingredient, the fat and/or oil-starch mixture, and the concentrated liquid soup, with which the freezer container is filled, to prepare a frozen food; and removing the prepared frozen food from the freezer container and sealing the prepared frozen food in a bag for microwave cooking; wherein the fat and/or oil-starch mixture has a starch content of 25 wt. % or less, the concentrated liquid soup has a viscosity at 25° C. of 5 Pa·s or more, and the frozen food for microwave cooking becomes ready to eat by pouring hot water after microwave cooking.

In the method for producing the frozen food for microwave cooking according to the present invention, a fat and/or oil in the fat and/or oil-starch mixture is preferably a non-Newtonian fluid at 25° C.

In the method for producing the frozen food for microwave cooking according to the present invention, the main ingredient is preferably noodles.

### Advantageous Effects of Invention

The present invention can provide a frozen food for microwave cooking having a viscous soup when eaten, the soup having natural thickness like that of a soup eaten at a restaurant, and a method for producing the same.

### BRIEF DESCRIPTION OF DRAWINGS

FIG. 1 is an explanatory diagram of a frozen food for microwave cooking according to an embodiment of the present invention.

FIG. 2 is an explanatory diagram of a modified example of the frozen food for microwave cooking according to the embodiment of the present invention.

FIG. 3 is a graph showing the relationship between the shear rate and viscosity of the fats and/or oils of Formulation Example 1-1 to Formulation Example 1-3 used in the fat and/or oil-starch mixtures according to the embodiment of the present invention.

### REFERENCE SIGNS LIST

1 Main ingredient
2 Upper side part
3 Fat and/or oil-starch mixture
4 Concentrated liquid soup

### DESCRIPTION OF EMBODIMENTS

The present invention will be described in detail below. However, the present invention is not limited to the following description.

### 1. Main Ingredient

The main ingredient according to the present invention includes noodles, cooked rice, and the like. The type of noodles is not particularly limited, and examples thereof include wheat noodles, buckwheat noodles, Chinese noodles, spaghetti, macaroni, and the like. Raw noodles or dried noodles of these noodles are cooked by boiling, steaming, or other cooking methods in advance, and then used as the main ingredient. The type of cooked rice is also not particularly limited, and examples thereof include white rice, brown rice, and mixed grain rice. Such rice is cooked, such rice is cooked and then fried to prepare fried rice, or such rice is fried and then cooked with soup to prepare pilaf. The rice after cooking in this way is used as the main ingredient.

### 2. Fat and/or Oil-Starch Mixture

The fat and/or oil-starch mixture according to the present invention is a mixture of fat and/or oil and starch, and does not contain water. The fat and/or oil in the fat and/or oil-starch mixture according to the present invention is not particularly limited as long as it is edible, and examples thereof include lard, tallow, chicken oil, palm oil, corn oil, rapeseed oil, sesame oil, olive oil, rice bran oil, soybean oil, safflower oil, and other fats and/or oils, and hydrogenated oils thereof. One or two or more of these fats and/or oils can be selected and used.

In particular, the fat and/or oil in the fat and/or oil-starch mixture according to the present invention is preferably a non-Newtonian fluid at 25° C. Regular oil that is liquid at 25° C. is a Newtonian fluid; however, by mixing fat and/or oil, such as shortening, the fat and/or oil can be made viscous, resulting in a non-Newtonian fluid at 25° C. If the viscosity is too low, the starch is not uniformly dispersed in the fat and/or oil in the fat and/or oil-starch mixture, and it is difficult to apply the mixture to the main ingredient. Therefore, the viscosity of the fat and/or oil in the fat and/or oil-starch mixture according to the present invention is preferably at least 100 mPa·s or more, and more preferably 250 mPa·s or more, at a shear rate of 10.2 [l/s] at 25° C. In contrast, if the viscosity is too high, when the frozen food is removed from the freezer container after freezing, it is difficult to remove the frozen food. Therefore, the viscosity is preferably at least 500 mPa·s or less, and more preferably 450 mPa·s or less, at a shear rate of 10.2 [l/s] at 25° C. The viscosity may be measured with a cone-plate rotational viscometer.

The starch in the fat and/or oil-starch mixture according to the present invention is not particularly limited, and examples thereof include potato starch, tapioca starch, cornstarch, waxy cornstarch, sago starch, mung bean starch, wheat starch, rice starch, and other starches, as well as modified starches obtained by subjecting these starches to gelatinization, etherification, esterification, oxidation, or other treatment. One or two or more of these starches can be selected and used. The starch used in the present invention is preferably starch with a gelatinization start temperature of 60° C. or less, and optimally hydroxypropyl starch (etherified starch).

The content of starch in the fat and/or oil-starch mixture according to the present invention is preferably 25 wt. % or less based on the total weight of the fat and/or oil-starch mixture. If the content of starch is too large, the starch is less likely to disperse uniformly and is gelatinized by microwave cooking to easily form lumps when eaten. The lower limit is not particularly limited; however, if the content of starch is too low, the amount of the fat and/or oil-starch mixture to be added to give the necessary viscosity increases depending on the type of soup. Thus, the content of starch is preferably 10 wt. % or more.

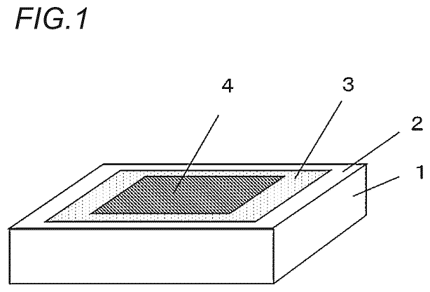

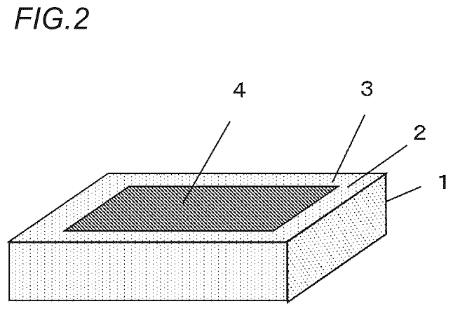

The fat and/or oil-starch mixture according to the present invention is preferably added so as to cover an upper side part or the entire surface of the main ingredient, as shown in FIG. 1 or 2. This can prevent not only the moisture of a concentrated liquid soup, described later, from transferring to the noodles, but also the bond between the main ingredients due to microwave cooking. In terms of uniform cooking, it is preferable to add the fat and/or oil-starch mixture so as to cover the entire surface of the main ingredient, as shown in FIG. 2.

The amount of the fat and/or oil-starch mixture according to the present invention added is preferably 3 to 20 wt. % based on the weight of the cooked main ingredient described above. If the amount of the fat and/or oil-starch mixture is less than 3 wt. %, it is difficult to cover an upper side part or the entire surface of the main ingredient when the freezer container is filled with the main ingredient. In contrast, if the amount of the fat and/or oil-starch mixture is more than 20 wt. %, a larger amount of the excess fat and/or oil-starch mixture accumulates at the bottom of the freezer container, the starch forms lumps during microwave cooking, and the frozen food after freezing is difficult to be removed from the freezer container. The amount of the fat and/or oil-starch mixture is more preferably about 5 to 12 wt. %.

### 3. Concentrated Liquid Soup

The viscosity at 25° C. of the concentrated liquid soup according to the present invention is preferably 5 Pa·s or more. The viscosity may be measured with a B-type viscometer. If the viscosity is less than 5 Pas, the moisture of the concentrated liquid soup easily transfers to the main ingredient. In addition, the concentrated liquid soup easily drips down from the upper side part of the main ingredient, the concentrated liquid soup is burnt during microwave cooking, and the main ingredient easily binds together. The viscosity is more preferably 8 Pa·s or more. The upper limit is not particularly limited; however, if the viscosity is too high, it is difficult to place the concentrated liquid soup. For this reason, the upper limit of viscosity is preferably 25 Pa·s or less.

The salt concentration of the concentrated liquid soup according to the present invention is preferably 7% (W/V) or less. If the salt concentration is higher than 7%, the concentrated liquid soup is burnt due to microwave cooking, and the main ingredient easily binds together. The salt concentration may be measured by the Mohr method. Since the concentrated liquid soup according to the present invention is directly filled in the frozen food and frozen, the filling amount of the soup can be increased in comparison with an attached concentrated liquid soup. In addition, since pH adjustment for storability is not necessary, the degree of concentration can be reduced, and flavor can be improved. The lower limit is not particularly limited; however, if the degree of concentration is too low, the filling amount of the liquid soup increases, which requires a longer cooking time by microwave cooking. In addition, the texture of the main ingredient becomes worse due to the transfer of moisture to the main ingredient during storage. Therefore, the salt concentration of the concentrated liquid soup is preferably adjusted to 3% or more.

The filling amount of the concentrated liquid soup according to the present invention is preferably 75 wt. % or less based on the weight of the cooked main ingredient. If the filling amount is too large, the concentrated liquid soup does not fit on the upper side part of the main ingredient and easily drips down. In addition, the microwave cooking time becomes longer, the concentrated liquid soup is burnt due to microwave cooking, and the main ingredient easily binds together. The lower limit is not particularly limited; however, if the filling amount is too low, the degree of concentration of the concentrated liquid soup increases, the concentrated liquid soup is overheated and burnt due to microwave cooking, and the main ingredient easily binds together. Therefore, the filling amount is preferably 25 wt. % or more based on the weight of the main ingredient. A more preferable range is 50 to 70 wt. %.

### 3. Production Process

A cooked main ingredient is prepared. Specifically, in the case of noodles, raw noodles prepared by noodle making or dried noodles are cooked by boiling or steaming by an ordinary method, and optionally washed with water and cooled. The resulting noodles are used as the main ingredient. In the case of cooked rice, rice is cooked, cooked rice is fried to prepare fried rice, or rice is fried and then cooked with soup to prepare pilaf. The rice after cooking in this way is used as the main ingredient.

Then, a freezer container is filled with the cooked main ingredient. The freezer container is not particularly limited as long as it has freezing resistance, and examples thereof include flexible plastic freezer containers and metal freezer containers. The shape of the container is also not particularly limited, and may be rectangular or round, or may have a convex part in the center.

After the freezer container is filled with the main ingredient, the fat and/or oil-starch mixture is placed to cover an upper side part of the main ingredient or the entire surface of the main ingredient, as shown in FIG. 1 or 2. The method of placing the fat and/or oil-starch mixture is not particularly limited. As shown in FIG. 1, when the fat and/or oil-starch mixture is placed on an upper side part of the main ingredient, it is preferable to place the fat and/or oil-starch mixture to cover a range wider than the upper side part on which a concentrated liquid soup, described later, is to be placed. Further, as shown in FIG. 2, the method in the case of covering the entire surface of the main ingredient is, for example, a method of blowing air after the fat and/or oil-starch mixture is placed, so that the fat and/or oil-starch liquid evenly covers the surface of the main ingredient. It is more preferable to cover the entire surface of the main ingredient because the transfer of moisture to the main ingredient can be prevented overall, the main ingredient easily loosens, heating is uniform, and the texture of the main ingredient and the natural viscosity of the soup can be obtained. After the main ingredient is covered with the fat and/or oil-starch mixture, the concentrated liquid soup is placed on the upper side part of the main ingredient, as shown in FIG. 1 or 2. The method of placing the concentrated liquid soup is not particularly limited. When the fat and/or oil-starch mixture is placed to cover the upper side part of the main ingredient as shown in FIG. 1, the concentrated liquid soup is uniformly placed within the range covered with the fat and/or oil-starch mixture. When the fat and/or oil-starch mixture covers the entire surface of the main ingredient as shown in FIG. 2, the concentrated liquid soup may be uniformly placed on the upper side part of the main ingredient.

After the concentrated liquid soup is placed, the freezer container is put in a freezer and frozen. The freezing method is not particularly limited, and conventional technology can be applied. For example, commercial freezing equipment, such as air-blast tunnel freezers, spiral freezers, wagon freezers, quick freezers, and brine flexible freezers, as well as general commercial and household freezers can be applied. Particularly preferred is quick freezing in a tunnel freezer or a spiral freezer at a temperature of −35° C. or less.

Then, the frozen food after freezing is removed from the freezer container. The method of removing the frozen food is not particularly limited. The flexible freezer container may be deformed to remove the frozen food, or the underside of the freezer container may be hit to remove the frozen food. The removed frozen food can be placed and sealed in a bag for microwave cooking, then sealed with an outer packaging material optionally with separate packages of condiments, furikake, etc., and put on the market as a frozen food for microwave cooking.

### 4. Cooking Method

In the case of a general frozen food with soup, it is cooked in a pot, or the frozen main ingredient is cooked in the microwave, and then transferred to a soup separately prepared by dissolving the attached soup in hot water in advance. Thus, cooking is completed. However, the frozen food for microwave cooking according to the present invention is cooked in the microwave and then transferred to a container, such as a bowl, and hot water is poured therein and stirred. Thus, cooking is completed. Since it is not necessary to prepare a soup separately, cooking is easier. In addition, direct filling of the liquid soup can reduce packaging materials, which is environmentally friendly. Furthermore, since it is cooked in the microwave in a state of a fat and/or oil-starch mixture, the starch contained in the fat and/or oil absorbs moisture and is slightly gelatinized before hot water is poured. Probably for this reason, in comparison with the case in which viscosity is expressed by a fat and/or oil-starch mixture in an attached soup as in Patent Literature 1, there is no artificial discomfort in the expression of viscosity when hot water is poured, and natural thickness like that of a soup eaten at a restaurant can be felt. Further, since the concentrated liquid soup is similarly heated in the microwave, the well cooked feeling is increased, the soup is well blended with the main ingredient, and the flavors were integrated as a whole.

The present embodiment will be described in more detail below with reference to Examples.

### EXAMPLES

### <Experiment 1> Examination of Fat and/or Oil-Starch Mixture

### Main Ingredient

To a raw material powder prepared by mixing 950 g of wheat flour and 50 g of starch, kneading water prepared by dissolving 10 g of salt and 10 g of kansui formulation (sodium carbonate 50:potassium carbonate 45:polymer phosphate 5) in 350 ml of water was added, and the mixture was kneaded with a mixer for 15 minutes to prepare noodle dough. The dough was rolled out with a roll into a noodle belt with a thickness of 1.5 mm, and cut out with a cutting blade No. 20 (square blade) to form raw noodle strings. Next, the resulting raw noodle strings were cut into 25 to 30 cm pieces per meal, boiled in boiling water for 30 seconds, and washed with cold water for 1 minute, followed by dipping in ice water for 30 seconds, cooling, and draining, thereby obtaining cooked Chinese noodles (main ingredient).

(Fat and/or Oil-Starch Mixture)

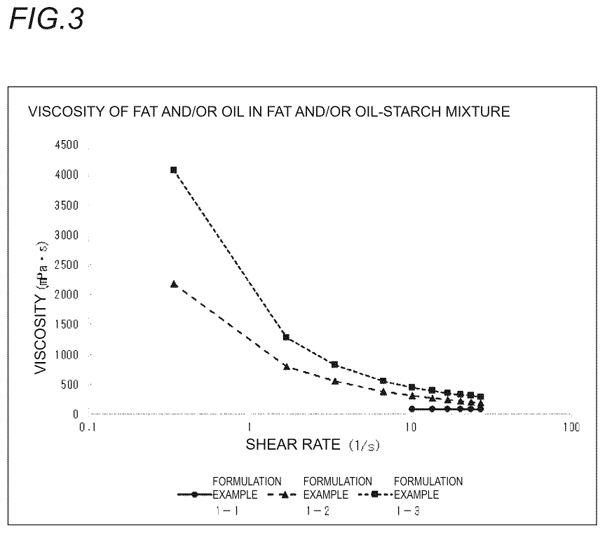

After rapeseed oil and shortening with the formulation of Formulation Examples 1-1 to 1-5 shown in Table 1 below were mixed, and starch was mixed to prepare fat and/or oil-starch mixtures. As for Formulation Examples 1-1 to 1-3, the viscosity of the fats and/or oils (rapeseed oil and shortening) used was measured. The measurement was carried out using a digital viscometer (LVDVNeat, EKO Instruments Co., Ltd.), a cone spindle (CPA-52Z), and an adapter (SC4-27). The viscosity was measured while changing the rotation speed every 60 seconds from 1 rpm to 80 rpm (shear rate: 0.34 to 27.2). The measurement results are shown in Table 2 and FIG. 3. As for Formulation Example 1-1, the viscosity could not be measured at a shear rate of less than 10.2. Similarly, as for Formulation Examples 1-1 to 1-3, the fat and/or oil-starch mixture was mixed, the resultant was left for 1 minute, and starch dispersibility was visually confirmed. When a large amount of starch was precipitated, this case was evaluated as poor, and when there was less starch precipitation and dispersion was generally maintained, this case was evaluated as good.

TABLE 1

| | Formu- | Formu- | Formu- | Formu- | Formu- |
|---|---|---|---|---|---|
| | lation | lation | lation | lation | lation |
| | Exam- | Exam- | Exam- | Exam- | Exam- |
| Material | ple 1-1 | ple 1-2 | ple 1-3 | ple 1-4 | ple 1-5 |
| Rapeseed oil | 80 | 76 | 68 | 80.75 | 71.25 |
| Shortening | 0 | 4 | 12 | 4.25 | 3.75 |
| Etherified potato starch | 20 | 20 | 20 | 15 | 25 |
| Total | 100 | 100 | 100 | 100 | 100 |
| Viscosity of fat and/or | 77 | 287 | 449 | | |
| oil (25° C., shear rate: | | | | | |
| 10.2 (1/s), mPa · s) | | | | | |
| Dispersibility | Poor | Good | Good | | |

TABLE 2

| | Formulation | Formulation | Formulation |
|---|---|---|---|
| Shear | Example 1-1 | Example 1-2 | Example 1-3 |
| rate | Viscosity | Viscosity | Viscosity |
| (1/s) | (mPa · s) | (mPa · s) | (mPa · s) |
| 0.34 | — | 1969 | 4078 |
| 1.70 | — | 727 | 1280 |
| 3.40 | — | 504 | 818 |
| 6.80 | — | 350 | 551 |
| 10.20 | 77 | 287 | 449 |
| 13.60 | 78 | 250 | 392 |
| 17.00 | 77 | 226 | 354 |
| 20.40 | 77 | 209 | 326 |
| 23.80 | 76 | 196 | 303 |
| 27.20 | 76 | 185 | 285 |

### (Concentrated Liquid Soup)

Then, the materials of Formulation Example 2-1 in Table 3 below were mixed and dissolved by heating to prepare a concentrated liquid soup (chicken white soup). As for Formulation Example 2-1, Formulation Example 2-2, and Formulation Example 2-3, the viscosity at 25° C. was measured with a B-type viscometer (VISCOMETER TVB-15M Roter No. 3, produced by Toki Sangyo Co., Ltd.).

TABLE 3

| | Formu- | Formu- | Formu- | Formu- |
|---|---|---|---|---|
| | lation | lation | lation | lation |
| | Exam- | Exam- | Exam- | Exam- |
| Material name | ple 2-1 | ple 2-2 | ple 2-3 | ple 2-4 |
| Soy sauce | 10 | 10 | 10 | 10 |
| Pork powder | 2.5 | 2.5 | 2.5 | 2.5 |
| Chicken powder | 4.5 | 4.5 | 4.5 | 4.5 |
| Potato powder | 5 | 5 | 5 | 5 |
| Chicken paste | 37.5 | 37.5 | 37.5 | 37.5 |
| Chicken extract | 4.5 | 4.5 | 4.5 | 4.5 |
| Lard | 1.5 | 1.5 | 1.5 | 1.5 |
| Chicken oil | 3.5 | 3.5 | 3.5 | 3.5 |
| Dextrin | 1.5 | 1.5 | 1.5 | 1.5 |
| Etherified phosphate- | 1 | 0.5 | 1 | 1 |
| crosslinked potato starch | | | | |
| Sugar | 2 | 2 | 2 | 2 |
| Monosodium glutamate | 1 | 1 | 1 | 1 |
| Nucleic acid | 0.1 | 0.1 | 0.1 | 0.1 |
| Succinic acid | 0.05 | 0.05 | 0.05 | 0.05 |
| Garlic paste | 0.35 | 0.35 | 0.35 | 0.35 |
| Chili pepper powder | 0.05 | 0.05 | 0.05 | 0.05 |
| White pepper powder | 0.05 | 0.05 | 0.05 | 0.05 |
| Shiitake mushroom extract | 0.5 | 0.5 | 0.5 | 0.5 |
| Water | 24.4 | 24.9 | 34.4 | 4.3 |
| Anhydrous citric acid | 0 | 0 | 0 | 0.1 |
| Total | 100 | 100 | 110 | 80 |
| Salt concentration % (W/V) | 4.9 | 4.9 | 4.4 | — |
| Viscosity (Pa · s) | 10 | 5 | 8 | — |

### Test Example 1-1

A freezer container (container diameter: 150 mm, container underside diameter: 140 mm, container height: 54 mm, container convex part diameter: 108 mm, container convex part underside diameter: 96.5 mm, container convex part height: 8 mm) was filled with 170 g of the cooked Chinese noodles as the main ingredient. Then, 12 g of the fat and/or oil-starch mixture of Formulation Example 1-1 was added from above the Chinese noodles, and compressed air was blown from above the container to apply the fat and/or oil-starch mixture to the entire surface of the noodles.

Then, from above the Chinese noodles to which the fat and/or oil-starch mixture was applied, 115 g of the concentrated liquid soup of Formulation Example 2-1 was uniformly placed on an upper side part of the Chinese noodles so that the soup did not fall down from the edge of the freezer container, as shown in FIG. 2.

After the concentrated liquid soup was placed, the entire freezer container was put in an air-blast quick freezer at −35° C. and frozen for 45 minutes. The frozen food (Chinese noodles) was removed from the freezer container and placed in a plastic bag for microwave cooking, thereby preparing a frozen food for microwave cooking (frozen Chinese noodles).

### Test Example 1-2

A frozen food for microwave cooking was prepared in the same manner as in Test Example 1-1, except that the fat and/or oil-starch mixture was changed to that of Formulation Example 1-2.

### Test Example 1-3

A frozen food for microwave cooking was prepared in the same manner as in Test Example 1-1, except that the fat and/or oil-starch mixture was changed to that of Formulation Example 1-3.

### Test Example 1-4

A frozen food for microwave cooking was prepared in the same manner as in Test Example 1-1, except that the fat and/or oil-starch mixture was changed to that of Formulation Example 1-4.

### Test Example 1-5

A frozen food for microwave cooking was prepared in the same manner as in Test Example 1-1, except that the fat and/or oil-starch mixture was changed to that of Formulation Example 1-5.

### Test Example 1-6

A frozen food for microwave cooking was prepared in the same manner as in Test Example 1-2, except that the amount of the fat and/or oil-starch mixture added was changed to 5 g.

### Test Example 1-7

A frozen food for microwave cooking was prepared in the same manner as in Test Example 1-2, except that the amount of the fat and/or oil-starch mixture added was changed to 34 g.

### Test Example 1-8

12 g of the fat and/or oil-starch mixture of Formulation Example 1-2 was placed in a separate packaging material, and 92 g of the concentrated liquid soup of Formulation Example 2-4 was placed in a separate packaging material. Cooked Chinese noodles as the main ingredient were frozen according to the method of Test Example 1-1 without adding a fat and/or oil-starch mixture and a concentrated liquid soup, and placed in a bag for microwave cooking, thereby preparing a frozen food for microwave cooking.

Test Example 1-2 and Test Example 1-8 were cooked in the microwave, eaten, and subjected to sensory evaluation. As for Test Example 1-2, the frozen food was cooked at 600 W for 4 minutes and then transferred to a container. Then, 200 ml of hot water was placed therein, and the concentrated liquid soup was dissolved while stirring. The resultant was eaten and evaluated. As for Test Example 1-8, the frozen food was cooked at 600 W for 4 minutes and then put in a soup prepared by placing the fat and/or oil-starch mixture of Formulation Example 1-2 and the concentrated liquid soup of Formulation Example 2-4 in a container in advance, and adding 220 ml of hot water to dissolve them. The resultant was eaten and evaluated. The evaluation was based on the thickness of the rich chicken white soup of a restaurant (Tenkaippin). Food with natural thickness that was almost the same as that in the restaurant was evaluated as excellent, food with natural thickness that was generally good was evaluated as good, food with artificial thickness that was inferior was evaluated as fair, and food with strong artificial thickness that was very inferior was evaluated as poor.

Test Examples 1-1 to 1-7 were evaluated for production suitability, such as the degree of application of the fat and/or oil-starch mixture to the noodle strings, dripping of the fat and/or oil, and removal of the frozen food after freezing. Test Examples 1-1 to 1-8 were evaluated for cooking suitability, such as loosening of the noodle strings and the formation of lumps in the soup during microwave cooking. Test Examples 1-1 to 1-7 were cooked in the same manner as in Test Example 1-2.

The evaluation results are shown in Table 4.

TABLE 4

| | Test | Test | Test | Test | Test | Test | Test | Test |
|---|---|---|---|---|---|---|---|---|
| Fat and/or oil- | Example | Example | Example | Example | Example | Example | Example | Example |
| starch mixture | 1-1 | 1-2 | 1-3 | 1-4 | 1-5 | 1-6 | 1-7 | 1-8 |
| Starch formulation | 20 | 20 | 20 | 10 | 25 | 20 | 20 | 20 |
| (%) | | | | | | | | |
| Fat and/or oil (25° C.) | Newtonian | Non- | Non- | Non- | Non- | Non- | Non- | Non- |
| | | Newtonian | Newtonian | Newtonian | Newtonian | Newtonian | Newtonian | Newtonian |
| Viscosity (mPa · s) | 79 | 280 | 440 | 280 | 280 | 280 | 280 | 280 |
| 25° C., shear rate: 10.2 | | | | | | | | |
| Filling | Direct | Direct | Direct | Direct | Direct | Direct | Direct | Separate |
| | filling | filling | filling | filling | filling | filling | filling | packaging |
| | | | | | | | | material |
| Filling amount (% of | 7 | 7 | 7 | 7 | 7 | 3 | 20 | 7 |
| main ingredient) | | | | | | | | |
| Degree of application | Whole | Whole | Whole | Whole | Whole | Partially | Whole | — |
| to noodles | | | | | | applied, | | |
| | | | | | | unevenness | | |
| | | | | | | generally | | |
| | | | | | | acceptable | | |
| Dripping of fat and/or | Large | Less | Less | Less | Less | Less | Large | — |
| oil | | | | | | | | |
| Taking out of frozen | Generally | Easy | Generally | Easy | Easy | Easy | Generally | Easy |
| food | acceptable | | acceptable | | | | acceptable | |
| Loosening of noodle | Generally | Good | Good | Good | Generally | Generally | Generally | Good |
| strings during cooking | acceptable | | | | acceptable | acceptable | acceptable | |
| Lumps in soup | Generally | No lumps | No lumps | No lumps | Generally | No lumps | Generally | No lumps |
| | acceptable | | | | acceptable | | acceptable | |
| Sensory evaluation | — | Excellent | — | — | — | — | — | Fair |
| (soup) | | | | | | | | |

From the results of the sensory evaluation of Test Example 1-2 and Test Example 1-8, in the frozen food for microwave cooking according to the present invention (frozen Chinese noodles), the artificial viscosity that appeared to be made with starch was reduced in comparison with the one with a liquid soup and a fat and/or oil-starch mixture divided into separate packages described in Patent Literature 1, and the viscosity was close to the thick, yet sharp and natural viscosity served in restaurants. The reason for this is assumed as follows. Specifically, the starch in the fat and/or oil-starch mixture was heated while absorbing moisture from the directly filled concentrated liquid soup and moisture from the noodles during microwave cooking, resulting in the progression of partial starch gelatinization. Then, hot water was poured thereinto for final gelatinization, which suppressed the feeling of artificial viscosity made with starch in comparison with Test Example 1-8, in which gelatinization was completed only with hot water. Further, the sample of Test Example 1-2 was directly filled with a concentrated liquid soup, and the microwave oven heated the concentrated liquid soup along with the noodles. Accordingly, in comparison with Test Example 1-8, the well cooked feeling of the soup itself increased, the noodles and soup were blended well, and the flavors were integrated as a whole.

For the fats and/or oils of Formulation Example 1-1 to Formulation Example 1-3, the relationship between shear rate and viscosity at 25° C. was measured. As a result, as shown in Table 2 and FIG. 3, the viscosity of the fat and/or oil in Formulation Example 1-1 almost did not change even when the shear rate changed, indicating that the fat and/or oil was a Newtonian fluid. As for the fats and/or oils in Formulation Example 1-2 and Formulation Example 1-3, the viscosity decreased as the shear rate increased, indicating that the fats and/or oils were non-Newtonian fluids.

From the evaluation results of the fat and/or oil-starch mixtures of Test Example 1-1 to Test Example 1-3, by adding shortening to obtain a non-Newtonian fluid as in the fats and/or oils of Formulation Example 1-2 and Formulation Example 1-3, rather than the fat and/or oil of Formulation Example 1-1, dripping of the fat and/or oil-starch mixture at the bottom of the container can be reduced after the fat and/or oil-starch mixture is applied to the noodles. It is difficult to compare the viscosity of a non-Newtonian fluid with the viscosity of a Newtonian fluid; however, as shown in FIG. 3 and Table 2, a viscosity higher than 100 mPa·s at a shear rate of 10.2 at 25° C. can indicate a non-Newtonian fluid. Furthermore, as in Formulation Example 1-2, when the viscosity is 250 mPa·s or more, dripping of the fat and/or oil-starch mixture can be prevented.

Conversely, as shown in Test Example 1-3, when shortening is added to the fat and/or oil-starch mixture to increase the viscosity of the non-Newtonian fluid of the fat and/or oil, it is difficult to fill the container with the fat and/or oil-starch mixture, and after filling, it is difficult for the mixture to spread over the entire surface of the noodle strings. Furthermore, it is difficult to remove the frozen food from the container when frozen. Accordingly, the viscosity of the fat and/or oil is preferably 500 mPa·s or less, and more preferably 450 mPa·s or less, at a shear rate of 10.2 at 25° C., as shown in Formulation Example 1-3. However, as shown in FIG. 1, when the fat and/or oil-starch mixture covers an upper side part of the frozen food, regarding the filling of the fat and/or oil-starch mixture, it is possible to further increase the viscosity of the non-Newtonian fluid by increasing the capacity of the filling machine or employing a process that uses a non-flexible plastic container or metal container to force out the mixture.

From the evaluation results of the fat and/or oil-starch mixtures of Test Example 1-4 and Test Example 1-5, the amount of starch mixed in the fat and/or oil-starch mixture is not a problem in a small amount; however, as shown in Test Example 1-5, loosening of the noodles begins to be slightly poor during cooking, and lumps begin to form in the soup. Thus, the amount of starch in the fat and/or oil-starch mixture is preferably 25 wt. % or less. However, if the amount of starch is too low, depending on the type of soup, it is necessary to add a larger amount of the fat and/or oil-starch mixture in order to achieve viscosity. Thus, it is considered that the amount of starch in the fat and/or oil-starch mixture is preferably 10 wt. % or more.

As shown in Test Examples 1-6 and 1-7, if the filling amount of the fat and/or oil-starch mixture in the main ingredient is too low, it is difficult to cover the entire surface of the main ingredient with the fat and/or oil-starch mixture. In contrast, if the filling amount is too large, the excess fat and/or oil-starch mixture accumulates at the bottom of the container, making it difficult to remove the frozen food from the freezer container. If the fat and/or oil-starch mixture accumulated at the bottom of the freezer container hardens in one place, lumps are easily formed in the soup, and the noodles do not loosen easily when heated. Therefore, the amount of the fat and/or oil-starch mixture added is preferably within the range of 3 to 20 wt. % based on the weight of the cooked main ingredient.

### <Experiment 2> Examination of Concentrated Liquid Soup

### Test Example 2-1

The materials of Formulation Example 2-2 in Table 2 below were mixed and dissolved by heating to prepare a concentrated liquid soup. A frozen food for frozen microwave cooking (frozen Chinese noodles) was prepared according to the method of Test Example 1-2, except that the concentrated liquid soup prepared in Formulation Example 2-2 was used.

### Test Example 2-2

The materials of Formulation Example 2-3 in Table 2 below were mixed and dissolved by heating to prepare a concentrated liquid soup. A frozen food for frozen microwave cooking (frozen Chinese noodles) was prepared according to the method of Test Example 1-2, except that 127 g of the concentrated liquid soup prepared in Formulation Example 2-3 was placed.

### Test Example 2-3

The materials of Formulation Example 3 in Table 5 below were mixed and dissolved by heating to prepare a concentrated liquid soup (ankake ramen).

TABLE 5

| Material | Formulation Example 3 |
|---|---|
| Soy sauce | 8 |
| Sugar | 5 |
| Salt | 3 |
| Potato powder | 1 |
| Shiitake mushroom extract | 0.5 |
| Grated ginger | 0.5 |
| Grated garlic | 1 |
| Oyster sauce | 3.5 |
| Pork extract | 11 |
| Black pepper | 0.05 |
| Red chili pepper | 0.05 |
| Monosodium glutamate | 2 |
| Nucleic acid | 0.2 |
| Succinic acid | 0.6 |
| Citric acid | 0.1 |
| Diced bamboo shoots 3 mm | 3.5 |
| Diced celery 5 mm | 1 |
| Minced pork | 2.5 |
| Etherified phosphate-crosslinked potato starch | 1.5 |
| Hydroxymethylcellulose | 1.5 |
| Water | 53.5 |
| Total | 100 |
| Salt concentration % (W/V) | 7 |
| Viscosity (Pa · s) | 15 |

Then, a freezer container (container diameter: 150 mm, container underside diameter: 140 mm, container height: 54 mm, container convex part diameter: 108 mm, container convex part underside diameter: 96.5 mm, container convex part height: 8 mm) was filled with 180 g of the cooked Chinese noodles prepared in Experiment 1 as the main ingredient. Then, 12.5 g of the fat and/or oil-starch mixture of Formulation Example 1-2 was added from above the Chinese noodles, and compressed air was blown from above the container to apply the fat and/or oil-starch mixture to the entire surface of the noodles.

Then, from above the Chinese noodles to which the fat and/or oil-starch mixture was applied, 85 g of the concentrated liquid soup of Formulation Example 3 was uniformly placed on an upper side part of the Chinese noodles so that the soup did not fall down from the edge of the container, as shown in FIG. 2.

After the concentrated liquid soup was placed, the entire freezer container was put in an air-blast quick freezer at −35° C. and frozen for 45 minutes. The frozen food (Chinese noodles) was removed from the freezer container and placed in a plastic bag for microwave cooking, thereby preparing a frozen food for microwave cooking (frozen Chinese noodles).

### Test Example 2-4

The materials of Formulation Example 4 in Table 6 below were mixed and dissolved by heating to prepare a concentrated liquid soup (sesame Tantan noodles).

TABLE 6

| Material | Formulation Example 4 |
|---|---|
| Etherified phosphate-crosslinked potato starch | 1.2 |
| Hydroxypropyl methylcellulose | 0.2 |
| Sugar | 5 |
| Salt | 2.5 |
| Grated ginger | 1 |
| Grated garlic | 0.5 |
| Pork extract | 3 |
| White sesame paste | 29.5 |
| Five-spice powder | 0.1 |
| Monosodium glutamate | 1 |
| Nucleic acid | 0.1 |
| Protein hydrolyzate | 1.9 |
| White miso | 3 |
| Diced bamboo shoots 3-mm square | 2 |
| Minced beef | 7 |
| Zasai 3 mm | 1 |
| Chopped white onion | 1.5 |
| Potion cream | 4.5 |
| Mayonnaise | 3 |
| Beef tallow | 1.5 |
| Water | 30.5 |
| Total | 100 |
| Salt concentration % (W/V) | 4.7 |
| Viscosity (Pa · s) | 25 |

Then, a freezer container (container diameter: 150 mm, container underside diameter: 140 mm, container height: 54 mm, container convex part diameter: 108 mm, container convex part underside diameter: 96.5 mm, container convex part height: 8 mm) was filled with 200 g of the cooked Chinese noodles prepared in Experiment 1-1 as the main ingredient. Then, 6 g of the fat and/or oil-starch mixture of Formulation Example 1-2 was added from above the Chinese noodles, and compressed air was blown from above the container to apply the fat and/or oil-starch mixture to the entire surface of the noodles.

Then, from above the Chinese noodles to which the fat and/or oil-starch mixture was applied, 105 g of the concentrated liquid soup of Formulation Example 4 was uniformly placed on an upper side part of the Chinese noodles so that the soup did not fall down from the edge of the container, as shown in FIG. 2.

After the concentrated liquid soup was placed, the entire freezer container was put in an air-blast quick freezer at −35° C. and frozen for 45 minutes. The frozen food (Chinese noodles) was removed from the freezer container and placed in a plastic bag for microwave cooking, thereby preparing a frozen food for microwave cooking (frozen Chinese noodles). Test Examples 2-1 to 2-4 were cooked in the microwave, eaten, and subjected to sensory evaluation. As for Test Examples 2-1 and 2-2, the frozen food was cooked at 600 W for 4 minutes and then transferred to a container, 200 ml of hot water was placed, and the concentrated liquid soup was dissolved while stirring. The resultant was eaten and evaluated. As for Test Example 2-3, the frozen food was cooked at 600 W for 4 minutes and then transferred to a container, 200 ml of hot water was placed, and the concentrated liquid soup was dissolved while stirring. The resultant was eaten and evaluated. As for Test Example 2-4, the frozen food was cooked at 600 W for 4 minutes and 30 seconds and then transferred to a container, 220 ml of hot water was placed, and the concentrated liquid soup was dissolved while stirring. The resultant was eaten and evaluated.

Test Examples 2-1 to 2-4 were evaluated for production suitability, such as the filling properties of the liquid soup, dripping from the upper side of the main ingredient, and removal of the frozen food, as well as cooking suitability, such as burning of the soup, loosening of the noodle strings, and the formation of lumps in the soup during cooking. The evaluation results are shown in Table 7 below.

TABLE 7

| | Test | Test | Test | Test |
|---|---|---|---|---|
| | Exam- | Exam- | Exam- | Exam- |
| Concentrated liquid soup | ple 2-1 | ple 2-1 | ple 2-3 | ple 2-4 |
| Salt concentration % | 4.9 | 4.4 | 7.0 | 3.4 |
| (W/V) | | | | |
| Viscosity (Pa · s) | 5 | 8 | 15 | 25 |
| Filling | Direct | Direct | Direct | Direct |
| | filling | filling | filling | filling |
| Filling amount (% of | 68 | 75 | 58 | 53 |
| main ingredient) | | | | |
| Filling properties | Good | Good | Good | Generally |
| | | | | acceptable |
| Dripping of concentrated | Slightly | Slightly | Not | Not |
| liquid soup | dripped | dripped | dripped | dripped |
| Taking out of frozen | Generally | Generally | Easy | Easy |
| food | acceptable | acceptable | | |
| Loosening of noodle | Generally | Generally | Generally | Good |
| strings during cooking | acceptable | acceptable | acceptable | |
| Lumps in soup | Generally | Generally | No lumps | No lumps |
| | acceptable | acceptable | | |
| Burnt soup | Not burnt | Not burnt | Generally | Not burnt |
| | | | acceptable | |

In Experiment 2, as shown in Table 7, the production suitability and cooking suitability were examined when using different soups, such as the concentrated liquid soups of Formulation Example 2-2 (prepared by reducing the soup viscosity of Formulation Example 2-1), Formulation Example 2-3 (prepared by diluting Formulation Example 2-1), Formulation Example 3 (ankake soup), and Formulation Example 4 (sesame Tantan soup). As a result, as shown in Test Example 2-1, when the viscosity at 25° C. of the concentrated liquid soup was about 5 Pas, the production suitability and cooking suitability were at generally acceptable levels, although the concentrated liquid soup sightly dripped. Further, as shown in Test Example 2-2, as the amount of the concentrated liquid soup placed, the soup can be placed on the upper side part of the main ingredient up to about 75 wt. % based on the main ingredient.

As shown in Test Example 2-3, the soup with a high salt concentration was not burnt but was slightly overheated by microwave heating. As a result, loosening was slightly poor in some of the noodles. Therefore, it is considered that the salt concentration is preferably 7% or less.

As shown in Test Example 2-4, if the viscosity of the soup increases, filling properties are deteriorated, and it is thus considered that the viscosity of the soup is preferably 25 Pa·s or less at 25° C.

Although not shown in the data, as a result of the sensory evaluation of each sample, viscosity was properly expressed in any Test Example, the main ingredient and the soup were blended better than when viscosity was expressed with an attached soup, and the soup had natural viscosity like that of a soup served in restaurants.

1: A frozen food for microwave cooking, comprising a cooked main ingredient, a fat and/or oil-starch mixture, and a concentrated liquid soup,
wherein an upper side part or the entire surface of the main ingredient is covered with the fat and/or oil-starch mixture,
wherein the concentrated liquid soup is placed on the upper side part of the main ingredient covered with the fat and/or oil-starch mixture,
wherein the main ingredient, the fat and/or oil-starch mixture, and the concentrated liquid soup is frozen in an integrated state,
wherein the fat and/or oil-starch mixture has a starch content of 25 wt. % or less,
wherein the weight of the fat and/or oil-starch mixture is 3 to 20 wt. % based on the weight of the main ingredient,
wherein the concentrated liquid soup has a viscosity at 25° C. of 5 Pa·s or more, wherein the weight of the concentrated liquid soup is 25 to 75 wt. % based on the weight of the main ingredient, and
wherein the frozen food for microwave cooking becomes ready to eat by pouring hot water after microwave cooking.

2: The frozen food for microwave cooking according to claim 1, wherein a fat and/or oil in the fat and/or oil-starch mixture is a non-Newtonian fluid at 25° C.

3: The frozen food for microwave cooking according to claim 1, wherein the main ingredient is noodles.

4: A method for producing a frozen food for microwave cooking, comprising:
filling a freezer container with a cooked main ingredient;
placing a fat and/or oil-starch mixture from an upper side of the main ingredient, with which the freezer container is filled, in an amount of 3 to 20 wt. % based on the weight of the cooked main ingredient;
placing a concentrated liquid soup from the upper side of the main ingredient, on which the fat and/or oil-starch mixture is placed, in an amount of 25 to 75 wt. % based on the weight of the cooked main ingredient;
freezing the cooked main ingredient, the fat and/or oil-starch mixture, and the concentrated liquid soup, with which the freezer container is filled, to prepare a frozen food; and
removing the prepared frozen food from the freezer container and sealing the prepared frozen food in a bag for microwave cooking,
wherein the fat and/or oil-starch mixture has a starch content of 25 wt. % or less,
wherein the concentrated liquid soup has a viscosity at 25° C. of 5 Pa·s or more, and
wherein the frozen food for microwave cooking becomes ready to eat by pouring hot water after microwave cooking.

5: The method for producing a frozen food for microwave cooking according to claim 4, wherein a fat and/or oil in the fat and/or oil-starch mixture is a non-Newtonian fluid at 25° C.

6: The method for producing a frozen food for microwave cooking according to claim 4, wherein the main ingredient is noodles.

7: The frozen food for microwave cooking according to claim 2, wherein the main ingredient is noodles.

8: The method for producing a frozen food for microwave cooking according to claim 5, wherein the main ingredient is noodles.
